(19) United States
(12) Patent Application Publication
(10) Pub. No.: US 2026/0203008 A1
(43) Pub. Date: Jul. 16, 2026

(54) SYNCHRONOUS AUDIO PROCESSING FOR MULTIPLE AUDIO STREAMS

(71) Applicant: QUALCOMM Incorporated, San Diego, CA (US)

(72) Inventors: Jaswanth THOTA, Bangalore (IN); Basavaraja MAGANAHALLI, Bengaluru (IN); Chun WANG, Markham (CA); Sanjay GUPTA, North York (CA); Santosh THOMAS, Bangalore (IN); Rajaraman RAMANARAYANAN, Bangalore (IN)

(21) Appl. No.: 19/016,278

(22) Filed: Jan. 10, 2025

(51) Int. Cl. G06F 3/16; G06F 13/28

(52) U.S. Cl. CPC G06F 3/165; G06F 13/28

(57) ABSTRACT

In some aspects, an audio controller may configure a synchronous audio group that includes multiple audio interfaces associated with multiple audio streams. The audio controller may send a first signal to each audio interface to initialize the multiple audio interfaces in the synchronous audio group. The audio controller may monitor respective initialization statuses associated with the multiple audio interfaces based on the first signal. The audio controller may send, after the initialization statuses indicate that the multiple audio interfaces have been initialized, a second signal to start each audio interface at a synchronous point associated with the multiple audio interfaces. Numerous other aspects are described.

### FIELD OF THE DISCLOSURE

Aspects of the present disclosure generally relate to audio processing and, for example, to synchronous audio processing for multiple audio streams.

### BACKGROUND

An audio subsystem on a system-on-chip (SoC) is a hardware and software integration that has capabilities to transfer high-quality audio data to and from external audio devices, such as one or more speakers and/or microphones. For example, an SoC that includes an audio subsystem may be included in a mobile device, such as a smartphone or a tablet, and/or in an embedded system or device, such as automotive (e.g., infotainment) system. An audio subsystem on an SoC may include various components, such as an audio processor or audio controller optimized for high-definition voice and/or multi-channel surround sound, a clock management component, and a codec that resides between audio hardware and a central processing unit to convert between analog and digital audio signals. In addition, an audio subsystem may include one or more interfaces, such as a pulse-code modulation (PCM) serial interface, a multi-stream time division multiplexed (TDM) interface, an inter-integrated circuit sound (I²S) interface, a multi-stream I²S interface (MI²S), a digital microphone (DMIC) interface, and/or an on-chip audio codec parallel interface.

To handle audio streams, an audio processor may batch, extract, and/or decode audio samples to and from file storage to achieve desired audio processing functions such as audio mixing and/or enhancing sound quality among other examples. The audio processing typically occurs periodically, when audio data is transmitted to an output (or sink) device such as a speaker, or received via an input (or source) device such as a microphone, to ensure that the audio stream is uninterrupted. The periodic events that trigger audio processing may depend on the start time, size, and/or other parameters associated with the audio stream. In an asynchronous audio processing system, multiple audio streams may be managed at different intervals by one or more audio processors. Asynchronous audio processing may be useful in certain applications, such as applications where different audio streams are processed independently (e.g., in multi-channel audio systems or when dealing with various audio sources). However, asynchronous audio processing in different intervals limits the simultaneous access to multiple audio streams that may be needed in some audio use cases. In contrast, synchronous audio processing handles multiple audio streams simultaneously, allowing the audio processor to manipulate a particular audio stream by cross-referencing other audio streams. Synchronous audio processing may be useful in scenarios where real-time audio synchronization is crucial. For example, by processing streams concurrently, synchronous audio processing enables noise cancellation algorithms to decouple speaker sound interference on the microphone samples or audio input path in a synchronous manner and also ensures that all audio elements are aligned, which provides a seamless and more immersive auditory experience.

### SUMMARY

Some aspects described herein relate to a method for synchronous audio processing. The method may include configuring, by an audio controller, a synchronous audio group that includes multiple audio interfaces associated with multiple audio streams. The method may include sending, by the audio controller, a first signal to each audio interface to initialize the multiple audio interfaces in the synchronous audio group. The method may include monitoring, by the audio controller, respective initialization statuses associated with the multiple audio interfaces based on the first signal. The method may include sending, by the audio controller after the initialization statuses indicate that the multiple audio interfaces have been initialized, a second signal to start each audio interface at a synchronous point associated with the multiple audio interfaces.

Some aspects described herein relate to a method for synchronous audio processing. The method may include copying, by a read direct memory access (DMA) block, one or more audio samples from memory to a buffer, wherein a read DMA period counter is incremented each time that the read DMA block accesses the memory. The method may include stopping the read DMA period counter based on a write DMA block starting a write DMA period counter to write an audio burst to the memory. The method may include releasing the read DMA period counter based on the write DMA period counter matching the read DMA period counter. The method may include sending, by the read DMA block, zero data to a corresponding audio interface while the read DMA period counter is stopped.

Some aspects described herein relate to an audio controller for wireless communication. The audio controller may include one or more memories and one or more processors coupled to the one or more memories. The one or more processors may be configured to configure a synchronous audio group that includes multiple audio interfaces associated with multiple audio streams. The one or more processors may be configured to send a first signal to each audio interface to initialize the multiple audio interfaces in the synchronous audio group. The one or more processors may be configured to monitor respective initialization statuses associated with the multiple audio interfaces based on the first signal. The one or more processors may be configured to send, after the initialization statuses indicate that the multiple audio interfaces have been initialized, a second signal to start each audio interface at a synchronous point associated with the multiple audio interfaces.

Some aspects described herein relate to an audio controller for wireless communication. The audio controller may include one or more memories and one or more processors coupled to the one or more memories. The one or more processors may be configured to copy, by a read DMA block, one or more audio samples from memory to a buffer, wherein a read DMA period counter is incremented each time that the read DMA block accesses the memory. The one or more processors may be configured to stop the read DMA period counter based on a write DMA block starting a write DMA period counter to write an audio burst to the memory. The one or more processors may be configured to release the read DMA period counter based on the write DMA period counter matching the read DMA period counter. The one or more processors may be configured to send, by the read DMA block, zero data to a corresponding audio interface while the read DMA period counter is stopped.

Some aspects described herein relate to a non-transitory computer-readable medium that stores a set of instructions for wireless communication by a one or more instructions that, when executed by one or more processors of an audio controller. The set of instructions, when executed by one or more processors of the audio controller, may cause the audio controller to configure a synchronous audio group that includes multiple audio interfaces associated with multiple audio streams. The set of instructions, when executed by one or more processors of the audio controller, may cause the audio controller to send a first signal to each audio interface to initialize the multiple audio interfaces in the synchronous audio group. The set of instructions, when executed by one or more processors of the audio controller, may cause the audio controller to monitor respective initialization statuses associated with the multiple audio interfaces based on the first signal. The set of instructions, when executed by one or more processors of the audio controller, may cause the audio controller to send, after the initialization statuses indicate that the multiple audio interfaces have been initialized, a second signal to start each audio interface at a synchronous point associated with the multiple audio interfaces.

Some aspects described herein relate to a non-transitory computer-readable medium that stores a set of instructions for wireless communication by a one or more instructions that, when executed by one or more processors of an audio controller. The set of instructions, when executed by one or more processors of the audio controller, may cause the audio controller to copy, by a read DMA block, one or more audio samples from memory to a buffer, wherein a read DMA period counter is incremented each time that the read DMA block accesses the memory. The set of instructions, when executed by one or more processors of the audio controller, may cause the audio controller to stop the read DMA period counter based on a write DMA block starting a write DMA period counter to write an audio burst to the memory. The set of instructions, when executed by one or more processors of the audio controller, may cause the audio controller to release the read DMA period counter based on the write DMA period counter matching the read DMA period counter. The set of instructions, when executed by one or more processors of the audio controller, may cause the audio controller to send, by the read DMA block, zero data to a corresponding audio interface while the read DMA period counter is stopped.

Some aspects described herein relate to an apparatus for wireless communication. The apparatus may include means for configuring a synchronous audio group that includes multiple audio interfaces associated with multiple audio streams. The apparatus may include means for sending a first signal to each audio interface to initialize the multiple audio interfaces in the synchronous audio group. The apparatus may include means for monitoring respective initialization statuses associated with the multiple audio interfaces based on the first signal. The apparatus may include means for sending, after the initialization statuses indicate that the multiple audio interfaces have been initialized, a second signal to start each audio interface at a synchronous point associated with the multiple audio interfaces.

Some aspects described herein relate to an apparatus for wireless communication. The apparatus may include means for copying, by a read DMA block, one or more audio samples from memory to a buffer, wherein a read DMA period counter is incremented each time that the read DMA block accesses the memory. The apparatus may include means for stopping the read DMA period counter based on a write DMA block starting a write DMA period counter to write an audio burst to the memory. The apparatus may include means for releasing the read DMA period counter based on the write DMA period counter matching the read DMA period counter. The apparatus may include means for sending, by the read DMA block, zero data to a corresponding audio interface while the read DMA period counter is stopped.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which synchronous audio processing for multiple audio streams may be implemented, in accordance with the present disclosure.

FIG. 2 is a diagram illustrating example components of a device, in accordance with the present disclosure.

FIGS. 3A-3C are diagrams illustrating examples related to processing one or more audio streams, in accordance with the present disclosure.

FIGS. 4A-4B are diagrams illustrating examples associated with synchronous audio processing for multiple audio streams that may have different enable controls and/or different sampling rates, in accordance with the present disclosure.

FIGS. 5A-5C are diagrams illustrating examples associated with synchronous audio processing for reading and writing multiple audio streams, in accordance with the present disclosure.

FIG. 6 is a diagram illustrating an example associated with synchronous audio processing for multiple audio streams, in accordance with the present disclosure.

FIG. 7 is a diagram illustrating an example associated with synchronous audio processing for multiple audio streams, in accordance with the present disclosure.

FIG. 8 is a flowchart of an example process associated with synchronous audio processing for multiple audio streams, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

In a processing system, a circular buffer (also known as a circular queue, cyclic buffer, or ring buffer) is a data structure used to store data in a continuous loop, as though the circular buffer were connected end-to-end. For example, a circular buffer typically has two indexes, which include a head index associated with a point at which a producer inserts a data item into the circular buffer and a tail index associated with a point at which a consumer obtains a next data item from the circular buffer. Accordingly, because data stored in a circular buffer is not reordered when data is consumed, circular buffers are well-suited to first-in-first-out (FIFO) implementations often used to buffer data streams. For example, in an audio system, a single audio stream may be associated with a circular buffer, and the audio stream may be processed using a ping-pong mechanism and a period interrupt. For example, ping-pong buffering is a specialized technique where a circular buffer is divided into two fixed-length partitions with an equal size, referred to herein as “ping” and “pong” halves of the circular buffer. Accordingly, when a direct memory access (DMA) hardware block finishes accessing either the ping half or the pong half of a circular buffer, a period interrupt request (IRQ) occurs to prompt a processing unit (e.g., a processing core) to process the audio data stored in that half of the circular buffer. For example, a read DMA period IRQ is triggered when a DMA block completes fetching (or reading) the audio data in the either the ping half or the pong half of the circular buffer, and a write DMA period IRQ is triggered when a DMA block completes writing audio data to either the ping half or the pong half of the circular buffer. In particular, the processing unit may process the audio data in the pong half of the circular buffer while the DMA block is accessing the ping half of the circular buffer, and vice versa. Furthermore, when there are multiple audio streams (e.g., corresponding to input audio data captured via a microphone and/or output audio data to be rendered via a speaker, each of which may include one or more channels), each audio stream may be assigned to a circular buffer and the multiple audio streams may be processed asynchronously, with different processing units or cores receiving IRQs from different DMA blocks at different times.

In some examples, to synchronize the audio streams received from different DMA blocks, software in all processing units or cores may wait until the last processing unit or core receives an IRQ from a DMA block to ensure that all DMA blocks have completed accessing a current half of the circular buffer. However, causing all processing units or cores to wait until the last IRQ is received before audio data is processed reduces a processing window for one or more processing units or cores due to a delay between the last IRQ and earlier IRQs. Furthermore, using the last IRQ as the prompt to trigger processing multiple audio streams may lead to data corruption or data conflicts, because different cores could be writing audio data to and reading audio data from the same half of a circular buffer at the same time.

Some aspects described herein generally relate to hardware-based mechanisms to enable synchronous processing for multiple audio streams. In some aspects, the hardware-based mechanisms may be configured to start all DMA blocks that access either half of a circular buffer to start at the same time and to align IRQs across different circular buffers as close in time as possible. For example, multiple audio interfaces may initiate DMA requests to read audio data from or write audio data to a circular buffer in a periodic manner (e.g., according to a time division multiplexing (TDM) configuration) based on an audio sampling rate, where different DMA blocks and/or audio interfaces may be associated with different enable controls that lead to an offset between enable signals and/or different sampling rates that may cause different audio interfaces to start at different intervals and/or have different preloading or initialization times. Accordingly, in some aspects, an audio controller may assign multiple audio interfaces to a group, and the audio controller may broadcast or otherwise time-align an enable signal among the multiple audio interfaces and associated DMA blocks to eliminate the offset between enable signals. Furthermore, the audio controller may monitor an initialization status associated with each DMA block, and may start all DMA blocks at a next synchronous point after all DMA blocks have completed initialization. For example, as described herein, a synchronous point for multiple audio interfaces or DMA blocks may be a clock edge at which positive edges of frame synchronization signals associated with different frequencies all intersect. In this way, starting all DMA blocks at the next synchronous point after all DMA blocks have completed initialization may eliminate an offset due to different audio interfaces having different sampling rates.

In addition, in some aspects, the memory controller may use padding techniques to align IRQs among read DMA and write DMA blocks. For example, a read DMA block may prefetch audio data from memory and copy the audio data into an audio FIFO buffer (e.g., the ping or pong half of a circular buffer) until a watermark level is reached, and the read DMA block may then start to serve buffered audio data to a processing unit or core to avoid buffer underrun. In contrast, a write DMA block may wait until a threshold amount of audio data to be written to memory has been collected in the audio FIFO buffer, and the write DMA block may then start to write the audio data to memory in a burst. The differences in read versus write processing may lead to an offset between read and write DMA period counters that may carry forward when later counter increments occur in periodic intervals. Accordingly, in some aspects, the audio controller may use padding techniques, where zero data is sent to an output audio interface associated with a read DMA block without accessing the audio FIFO buffer, thereby preventing the read DMA counter from being incremented. In this way, when there is a misalignment between a read DMA period counter and a write DMA period counter, the read DMA period counter may be stopped until the write DMA period counter equals the read DMA period counter, which may reduce an offset and misalignment between read DMA period IRQs and write DMA period IRQs.

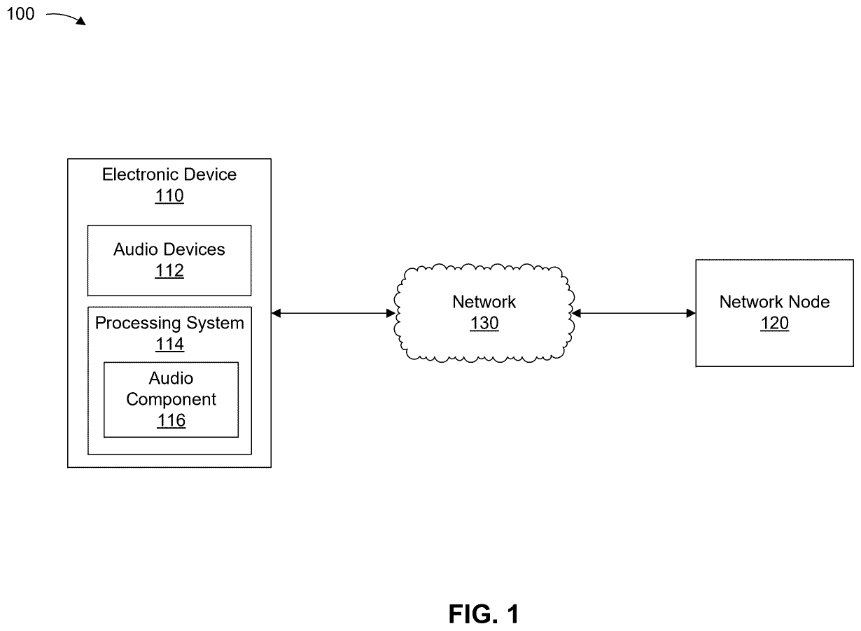

FIG. 1 is a diagram illustrating an example environment in which synchronous audio processing for multiple audio streams may be implemented, in accordance with the present disclosure. As shown in FIG. 1, the environment 100 may include an electronic device 110 and a network node 120 that may communicate with one another via a network 130. The electronic device 110 and the network node 120 may be dispersed throughout the network 130, and the electronic device 110 and the network node 120 may each be stationary and/or mobile. The network 130 may include wired connections, wireless connections, or a combination of wired and wireless connections to enable communication among the electronic device 110 and the network node 120.

The electronic device 110 includes one or more devices capable of providing synchronous audio processing for multiple audio streams. For example, the electronic device 110 may include a wired and/or wireless communication and/or computing device, such as a user equipment (UE), a mobile phone (e.g., a smart phone, a radiotelephone, and/or the like), a laptop computer, a tablet computer, a handheld computer, a desktop computer, a gaming device, a wearable communication device (e.g., a smart wristwatch or smart eyeglasses), an automotive device, or the like.

The network node 120 may include one or more devices capable of receiving, processing, storing, routing, and/or providing traffic (e.g., a packet and/or other information or metadata) in a manner described herein. For example, the network node 120 may include a router, such as a label switching router (LSR), a label edge router (LER), an ingress router, an egress router, a provider router (e.g., a provider edge router or a provider core router), a virtual router, or another type of router. Additionally, or alternatively, the network node 120 may include a gateway, a switch, a firewall, a hub, a bridge, a reverse proxy, a server (e.g., a proxy server, a cloud server, or a data center server), a load balancer, and/or a similar device. Additionally, or alternatively, the network node 120 may include a base station (a Node B, an eNB, and/or a gNB, among other examples), a relay device, a network controller, an access point, a transmit receive point (TRP), an apparatus, a device, a computing system, one or more components of any of these, and/or another processing entity configured to perform one or more aspects of the techniques described herein. For example, the network node 120 may be an aggregated base station and/or one or more components of a disaggregated base station (e.g., a central unit (CU), a distributed unit (DU), and/or a radio unit (RU), also known as a remote radio unit (RRU) or remote radio head (RRH)). In some aspects, the network node 120 may be a physical device implemented within a housing, such as a chassis. In some aspects, the network node 120 may be a virtual device implemented by one or more computing devices of a cloud computing environment or a data center. In some aspects, a group of network nodes 120 may be a group of data center nodes that are used to route traffic flow through a network.

The network 130 includes one or more wired and/or wireless networks. For example, the network 130 may include a cellular network (e.g., a code division multiple access (CDMA) network, a 3G network, a 4G network, a 5G network, a 6G network, or another type of next generation network, or the like), a public land mobile network (PLMN), a local area network (LAN) or a wireless LAN (WLAN), a wide area network (WAN) or a wireless WAN (WWAN), a personal area network (PAN) or a wireless PAN (WPAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

As shown, the electronic device 110 may include one or more audio devices 112. For example, the audio devices 112 may include any suitable device that has a capability to receive, output, reproduce, record, or otherwise process audio data. For example, the audio devices 112 may include a microphone, speakers, a radio receiver, an audiovisual receiver, a compact disc player, a tape recorder, an amplifier, a turntable, a mixing console, an audio effects unit, headphones, or another suitable device.

As further shown in FIG. 1, the electronic device 110 may include a processing system 114. The processing system 114 may include one or more components (or subcomponents), such as an audio component 116, and/or one or more other components described herein. For example, a component of the processing system 114 may be, be similar to, include, or be included in at least one memory, at least one communication interface, or at least one processor. The processing system 114 may generally correspond to a system that includes one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. For example, as shown in FIG. 1, the processing system 114 may include the audio component 116, which may be configured to perform one or more tasks or operations described herein. In some aspects, the processing system 114 may perform or cause one or more components to perform one or more communication tasks as described herein. Although depicted with reference only to the electronic device 110, the network node 120 may include a processing system.

As used herein, the processing system 114 may include a communication interface, which may be any suitable interface that enables communication (e.g., wireless communication, wired communication, or a combination thereof) between the electronic device 110 and another entity or device, such as the network node 120. The communication interface may include electronic circuitry that enables the electronic device 110 to transmit, receive, or otherwise perform the communication. For example, the communication interface may include a transmission component, a reception component, and/or a transceiver configured to communicate with other devices, such as via a wired connection, a wireless connection, or a combination of wired and wireless connections. In some examples, the communication interface may include one or more radio frequency (RF) components, an RF front end, one or more antennas, one or more transmit or receive processors, a demodulation component, and/or a modulation component, among other examples. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), and/or a serial peripheral interface (SPI), among other examples.

As described in more detail elsewhere herein, the electronic device 110 may (e.g., the processing system 114 may, or the processing system 114 may cause the audio component 116 to) configure a synchronous audio group that includes multiple audio interfaces associated with multiple audio streams; send a first signal to each audio interface to initialize the multiple audio interfaces in the synchronous audio group; monitor respective initialization statuses associated with the multiple audio interfaces based on the first signal; and send, after the initialization statuses indicate that the multiple audio interfaces have been initialized, a second signal to start each audio interface at a synchronous point associated with the multiple audio interfaces. Additionally, or alternatively, the electronic device 110, the audio devices 112, the processing system 114, and/or the audio component 116 may perform one or more other operations described herein.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

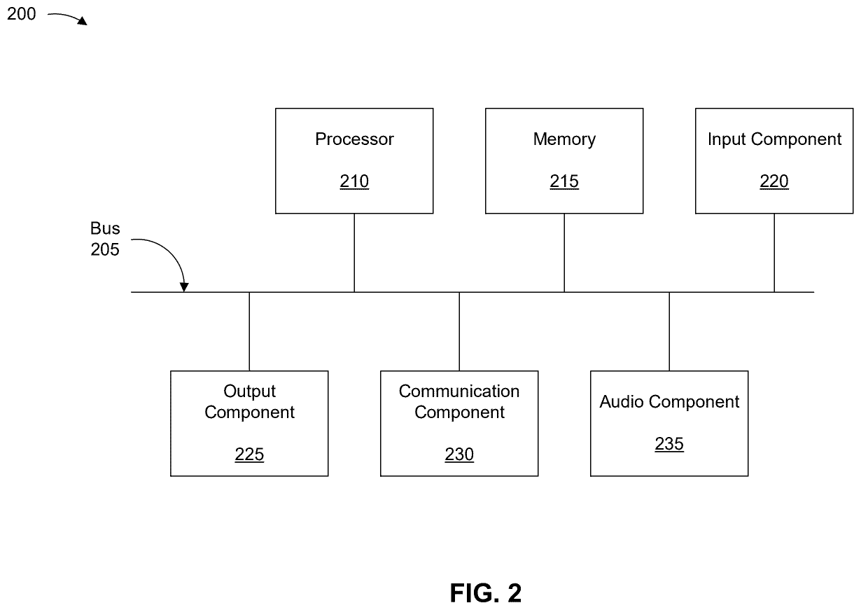

FIG. 2 is a diagram illustrating example components of a device 200, in accordance with the present disclosure. The device 200 may correspond to electronic device 110 and/or network node 120. In some aspects, electronic device 110 and/or network node 120 may include one or more devices 200 and/or one or more components of the device 200. As shown in FIG. 2, the device 200 may include a bus 205, a processor 210, a memory 215, an input component 220, an output component 225, a communication component 230, and/or an audio component 235.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 225 may enable the device 200 to provide output, such as via a display, a speaker, and/or a light-emitting diode. The communication component 230 may enable the device 200 to communicate with other devices via a wired connection and/or a wireless connection. For example, the communication component 230 may include a receiver, a transmitter, a transceiver, a modem, a network interface card, and/or an antenna.

The audio component 235 includes one or more devices capable of receiving, generating, storing, transmitting, processing, detecting, and/or providing synchronous audio processing for multiple audio streams, as described elsewhere herein. For example, in some aspects, the audio component 235 may configure a synchronous audio group that includes multiple audio interfaces associated with multiple audio streams; send a first signal to each audio interface to initialize the multiple audio interfaces in the synchronous audio group; monitor respective initialization statuses associated with the multiple audio interfaces based on the first signal; and/or send, after the initialization statuses indicate that the multiple audio interfaces have been initialized, a second signal to start each audio interface at a synchronous point associated with the multiple audio interfaces. Additionally, or alternatively, the audio component 235 may perform other operations described herein.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, the device 200 may include means for configuring a synchronous audio group that includes multiple audio interfaces associated with multiple audio streams; means for sending a first signal to each audio interface to initialize the multiple audio interfaces in the synchronous audio group; means for monitoring respective initialization statuses associated with the multiple audio interfaces based on the first signal; and/or means for sending, after the initialization statuses indicate that the multiple audio interfaces have been initialized, a second signal to start each audio interface at a synchronous point associated with the multiple audio interfaces. In some aspects, the means for the device 200 to perform processes and/or operations described herein may include one or more components of the device 200 described in connection with FIG. 2, such as bus 205, processor 210, memory 215, input component 220, output component 225, communication component 230, and/or audio component 235, among other examples.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

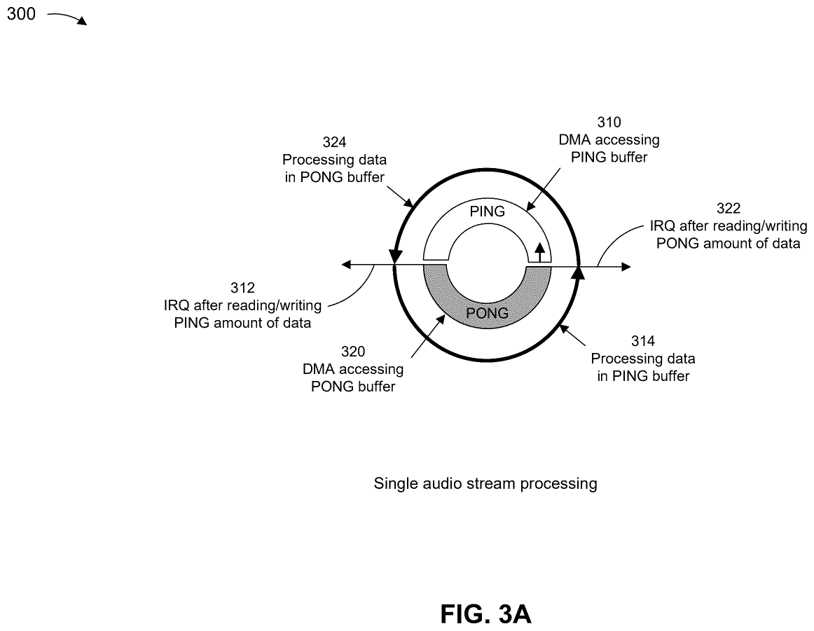

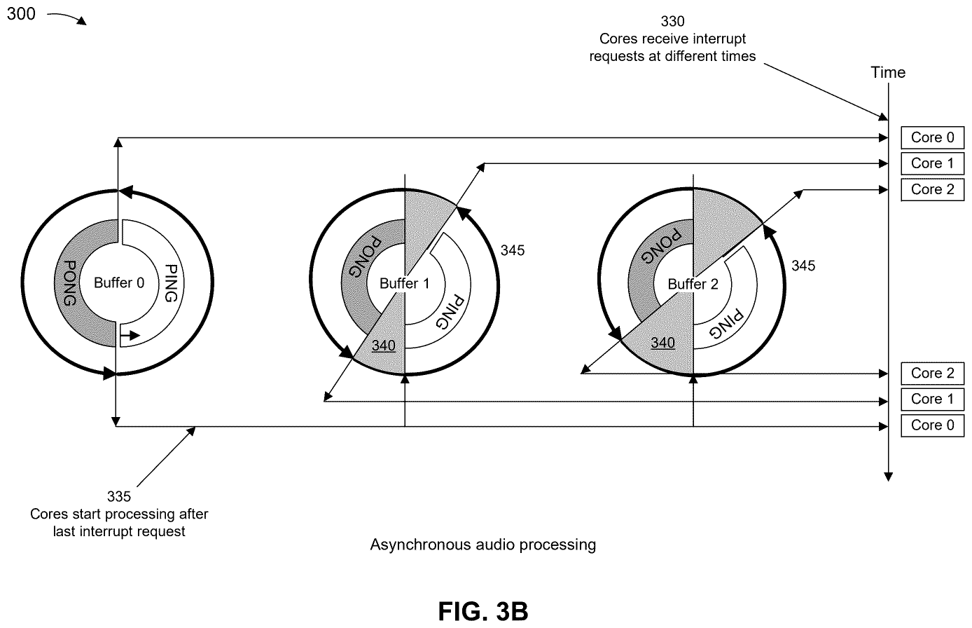

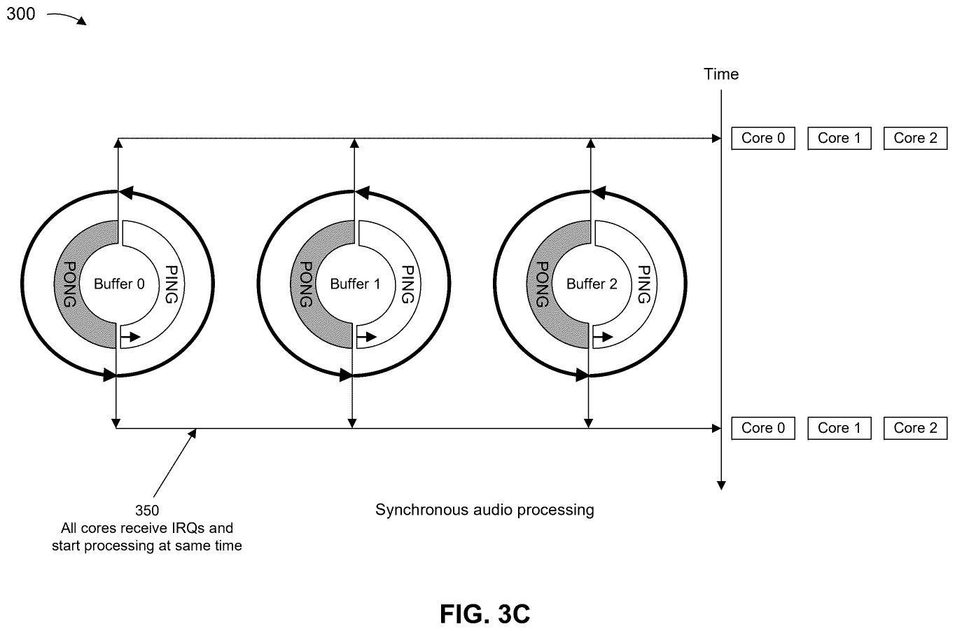

FIGS. 3A-3C are diagrams illustrating examples 300 related to processing one or more audio streams, in accordance with the present disclosure. In a processing system, a circular buffer (also known as a circular queue, cyclic buffer, or ring buffer) is a data structure used to store data in a continuous loop, as though the circular buffer were connected end-to-end. For example, a circular buffer typically has two indexes, which include a head index associated with a point at which a producer inserts a data item into the circular buffer and a tail index associated with a point at which a consumer obtains a next data item from the circular buffer. Accordingly, because data stored in a circular buffer is not reordered when data is consumed, circular buffers are well-suited to FIFO implementations often used to buffer data streams.

For example, as shown in FIG. 3A. a single audio stream may be associated with a circular buffer, and the audio stream may be processed using a ping-pong mechanism and a period interrupt. For example, ping-pong buffering is a specialized technique where a circular buffer is divided into two fixed-length partitions with an equal size, referred to herein as “ping” and “pong” halves of the circular buffer. Accordingly, when a DMA block finishes accessing either the ping half or the pong half of a circular buffer, a period IRQ occurs to prompt a processing unit (e.g., a processing core) to process the audio data stored in that half of the circular buffer. For example, as shown by reference number 310 in FIG. 3A, a DMA block may access the ping half of the circular buffer (e.g., to read data from or write data to the ping half of the circular buffer). As shown by reference number 312, the DMA block may then trigger a period IRQ after reading from memory or writing to memory an amount of audio data that corresponds to the size of the ping half of the circular buffer. As shown by reference number 314, a processing unit or core may then process the audio data in the ping half of the circular buffer after receiving the period IRQ. Similarly, as shown by reference number 320, a DMA block may access the pong half of the circular buffer (e.g., to read data from or write data to the pong half of the circular buffer). As shown by reference number 322, the DMA block may then trigger a period IRQ after reading from memory or writing to memory an amount of audio data that corresponds to the size of the pong half of the circular buffer. As shown by reference number 324, a processing unit or core may then process the audio data in the pong half of the circular buffer.

As shown in FIG. 3B, when there are multiple audio streams (e.g., corresponding to input audio data captured via a microphone and/or output audio data to be rendered via a speaker, each of which may include one or more channels), each audio stream may be assigned to a circular buffer and the multiple audio streams may be processed asynchronously. For example, as shown by reference number 330, each audio stream and corresponding buffer may be associated with a processing unit or core, and different processing units or cores may receive period IRQs from different DMA blocks at different times. In some examples, as shown by reference number 335, to synchronize the audio streams received from different DMA blocks, software in all processing units or cores may wait until the last processing unit or core receives an IRQ from a DMA block to ensure that all DMA blocks have completed accessing a current half of the circular buffer. However, as shown by reference number 340, using the last IRQ as the prompt to trigger processing multiple audio streams may lead to data corruption or data conflicts, because a DMA and a processing unit or core could be accessing the same half of a circular buffer at the same time. Furthermore, as shown by reference number 345, causing all processing units or cores to wait until the last IRQ is received before audio data is processed reduces a processing window for one or more processing units or cores due to a delay between the last IRQ and earlier IRQs.

Accordingly, some aspects described herein generally relate to hardware-based mechanisms to enable synchronous processing for multiple audio streams. For example, as shown in FIG. 3C, and by reference number 350, the hardware-based mechanisms may be configured to start all DMA blocks that access either half of a circular buffer to start at the same time and to align IRQs across different circular buffers as close in time as possible. For example, multiple audio interfaces may initiate DMA requests to read audio data from or write audio data to a circular buffer in a periodic manner (e.g., according to a TDM configuration) based on an audio sampling rate, where different DMA blocks and/or audio interfaces may be associated with different enable controls that lead to an offset between enable signals and/or different sampling rates that may cause different audio interfaces to start at different intervals and/or have different preloading or initialization times. Accordingly, in some aspects, an audio controller may assign multiple audio interfaces to a group, and the audio controller may broadcast or otherwise time-align an enable signal among the multiple audio interfaces and associated DMA blocks to eliminate the offset between enable signals. Furthermore, the audio controller may monitor an initialization status associated with each DMA block, and may start all DMA blocks at a next synchronous point after all DMA blocks have completed initialization. For example, as described herein, a synchronous point for multiple audio interfaces or DMA blocks may be a clock edge at which positive edges of frame synchronization signals associated with different frequencies all intersect. In this way, starting all DMA blocks at the next synchronous point after all DMA blocks have completed initialization may eliminate an offset due to different audio interfaces having different sampling rates.

In addition, in some aspects, the memory controller may use padding techniques to align IRQs among read DMA and write DMA blocks. For example, a read DMA block may prefetch audio data from memory and copy the audio data into an audio FIFO buffer (e.g., the ping or pong half of a circular buffer) until a watermark level is reached, and the read DMA block may then start to serve buffered audio data to a processing unit or core to avoid buffer underrun. In contrast, a write DMA block may wait until a threshold amount of audio data to be written to memory has been collected in the audio FIFO buffer, and the write DMA block may then start to write the audio data to memory in a burst. The differences in read versus write processing may lead to an offset between read and write DMA period counters that may carry forward when later counter increments occur in periodic intervals. Accordingly, in some aspects, the audio controller may use padding techniques, where zero data is sent to an output audio interface associated with a read DMA block without accessing the audio FIFO buffer, thereby preventing the read DMA counter from being incremented. In this way, when there is a misalignment between a read DMA period counter and a write DMA period counter, the read DMA period counter may be stopped until the write DMA period counter equals the read DMA period counter, which may reduce an offset and misalignment between read DMA period IRQs and write DMA period IRQs.

As indicated above, FIGS. 3A-3C are provided as examples. Other examples may differ from what is described in connection with FIGS. 3A-3C.

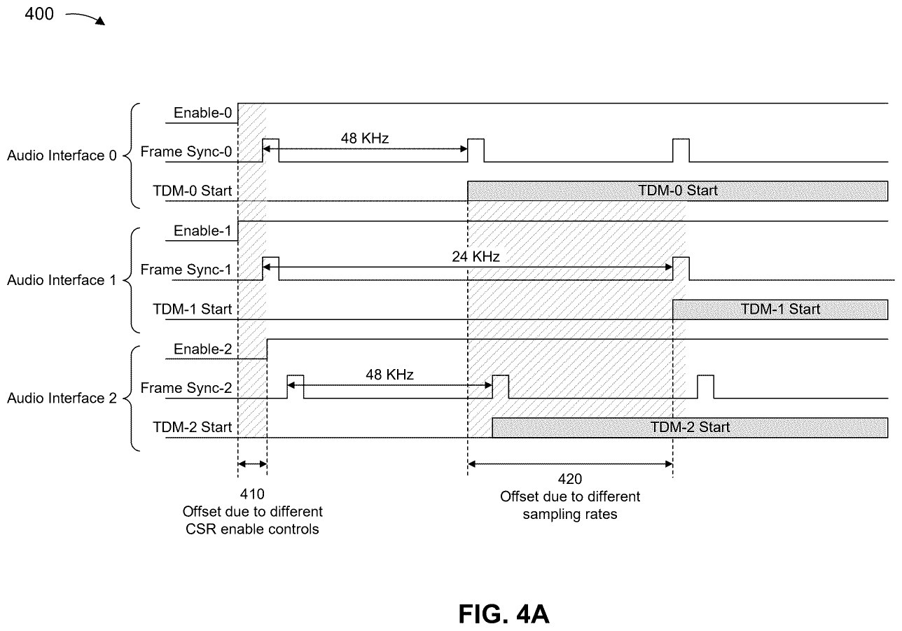

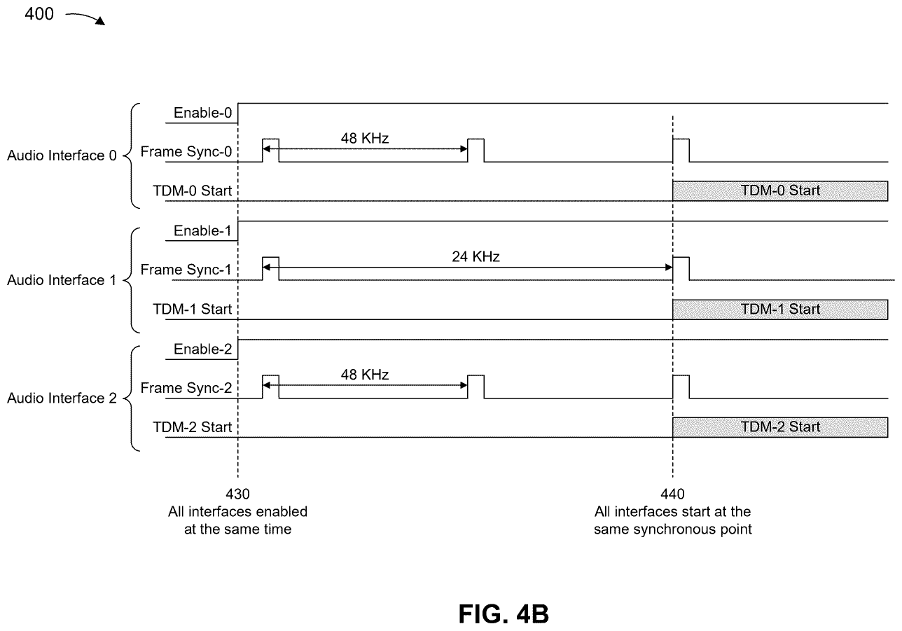

FIGS. 4A-4B are diagrams illustrating examples 400 associated with synchronous audio processing for multiple audio streams that may have different enable controls and/or different sampling rates, in accordance with the present disclosure.

In particular, FIG. 4A illustrates signals associated with multiple audio interfaces that are each associated with a respective audio stream. For example, FIG. 4A illustrates an example with three audio interfaces, each of which may be associated with an audio input channel (e.g., microphone data) or an audio output channel (e.g., speaker data). In general, each audio interface is associated with an enable signal that may be asserted to enable the corresponding audio interface, a frame synchronization signal based on a sampling rate associated with the corresponding audio interface, and a TDM start signal that indicates when the corresponding audio interface starts to sample audio data to be read from or written to an associated audio FIFO buffer (e.g., the ping half or the pong half of a circular buffer). For example, the TDM start for an audio interface may refer to a time when the audio interface starts to send audio output data in a transmit path to an audio output device (e.g., speaker) or a time when the audio interface starts to capture audio input data in a receive path from an audio input device (e.g., microphone). In general, each audio interface may initiate a DMA request to the associated circular buffer in a periodic manner based on an audio sampling rate, whereby the start of the DMA blocks may be proportional to the start of the TDM interfaces. Furthermore, the TDM start time for each audio interface is always aligned with respect to a reference point associated with the frame synchronization signal.

However, different audio interfaces may not start at the same time for various reasons. For example, the enable signal associated with each audio interface may be controlled using a control status register (CSR), where there may be more audio streams than CSRs in some examples. For example, FIG. 4A illustrates a scenario where an audio system includes two CSRs, such that an enable signal may be asserted for the first audio interface (shown as “Audio Interface 0”) and a second audio interface (shown as “Audio Interface 1”) at the same time using the two CSRs. Accordingly, as shown by reference number 410, enabling all DMA blocks and audio interfaces may involve multiple CSR writes due to different enable controls for each audio interface, resulting in an offset between the enable signals for one or more audio interfaces. For example, each audio interface may use one frame synchronization pulse as a preloading duration for sampling audio input or audio output data. Accordingly, FIG. 4A illustrates an example scenario where a CSR may be used to assert the enable signal for the first audio interface and the third audio interface, but the enable signal for the third audio interface cannot be asserted until after the first pulse of the frame synchronization signal for the first audio interface. As a result, even though the first audio interface and the third audio interface have the same sampling rate (e.g., 48 kilohertz (kHz)), the frame synchronization signals for the first and third audio interfaces are offset in time by the difference between the times when the enable signals are asserted for each interface.

Additionally, or alternatively, different DMAs or audio interfaces may not start at the same time due to a difference in sampling rates. For example, FIG. 4A illustrates a scenario where the first and third audio interfaces are associated with the same sampling rate (e.g., 48 kHz), and the second audio interface is associated with a different sampling rate (e.g., 24 kHz). Accordingly, as shown in FIG. 4A, the frame synchronization signals for the first and third audio interfaces may include two sampling intervals for each sampling interval for the second audio interface. Because each audio interface starts to send audio output data in a transmit path or capture audio input data in a receive path at a frame synchronization reference point, audio interfaces associated with different sampling rates may have different frame synchronization reference points that result in different start times for the respective audio interfaces. For example, as shown by reference number 420, a start time for the first audio interface may be offset from a start time for the second audio interface due to the different sampling rates used by the first audio interface and the second audio interface. In addition, although not explicitly depicted in FIG. 4A, the start times for different audio interfaces may be offset in time due to differences in a preloading and/or initialization time for each interface.

Accordingly, in some aspects, multiple audio interfaces may be grouped to eliminate or reduce one or more offsets between the multiple audio interfaces, which may allow the multiple audio interfaces to start processing audio data at the same time. For example, in some aspects, an audio controller may include a hardware block to centralize controls for each audio interface in the group, which may enable each DMA block and associated audio interface to start at the same time. For example, as shown by reference number 430, the audio controller may send an enable signal to each audio interface at the same time, where the enable signal may be broadcasted or otherwise asserted at the same time to eliminate an offset associated with different CSR controls for different audio interfaces. Furthermore, after the enable signal has been asserted for each audio interface, the audio controller may monitor an initialization status associated with each audio interface. For example, as described herein, each audio interface may perform preloading to obtain audio data to be read from or written to memory, and the audio interfaces may finish initialization at different times. Accordingly, as shown by reference number 440, after the initialization statuses indicate that all of the audio interfaces have been initialized, the audio controller may start all audio interfaces at a next synchronous point that accounts for differences in sampling rates between the different audio interfaces. For example, as described herein, the synchronous point may refer to a clock edge at which positive edges of the frame synchronization signals for all audio interfaces intersect (e.g., for a first clock having a 3 nanoseconds (ns) period and a second clock having a 1 ns period, the synchronous point for the first and second clock periods occur every 3 ns, or at each pulse of the first clock). As applied to the audio interfaces shown in FIG. 4B, the synchronous point occurs at every pulse of the frame synchronization signal associated with the second audio interface, which has a sampling rate that is twice the sampling rate of the first and third audio interfaces.

As indicated above, FIGS. 4A-4B are provided as examples. Other examples may differ from what is described in connection with FIGS. 4A-4B.

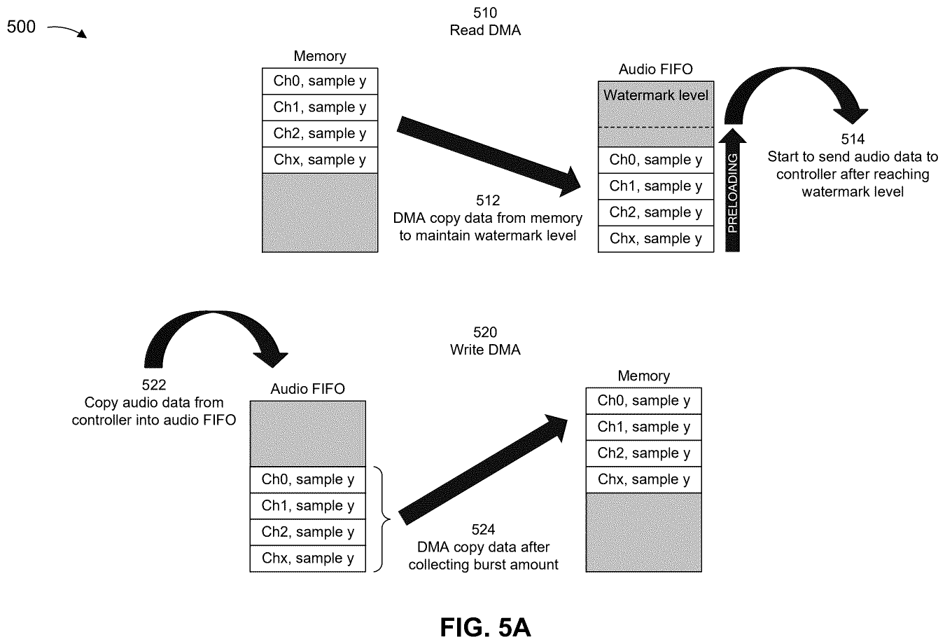

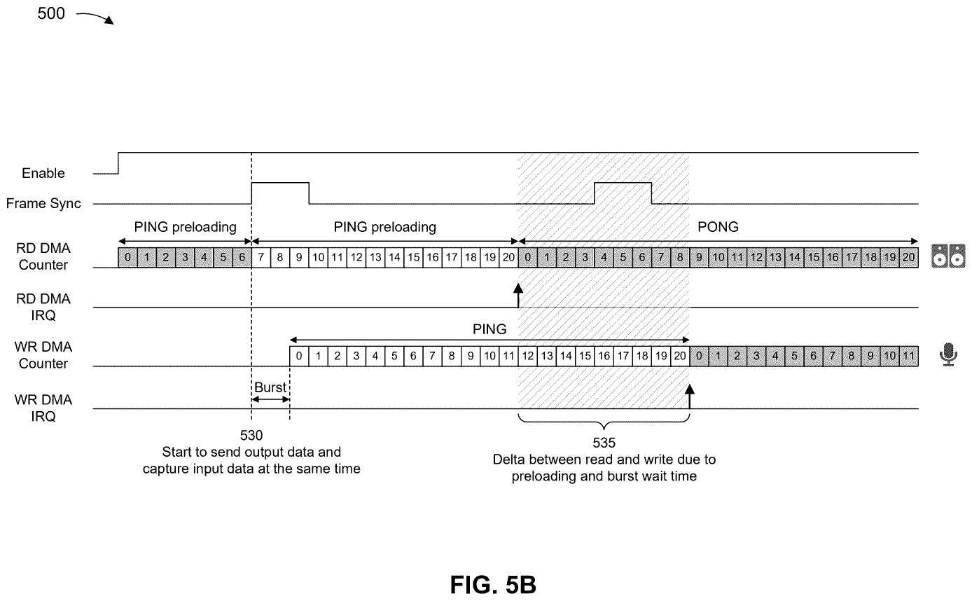

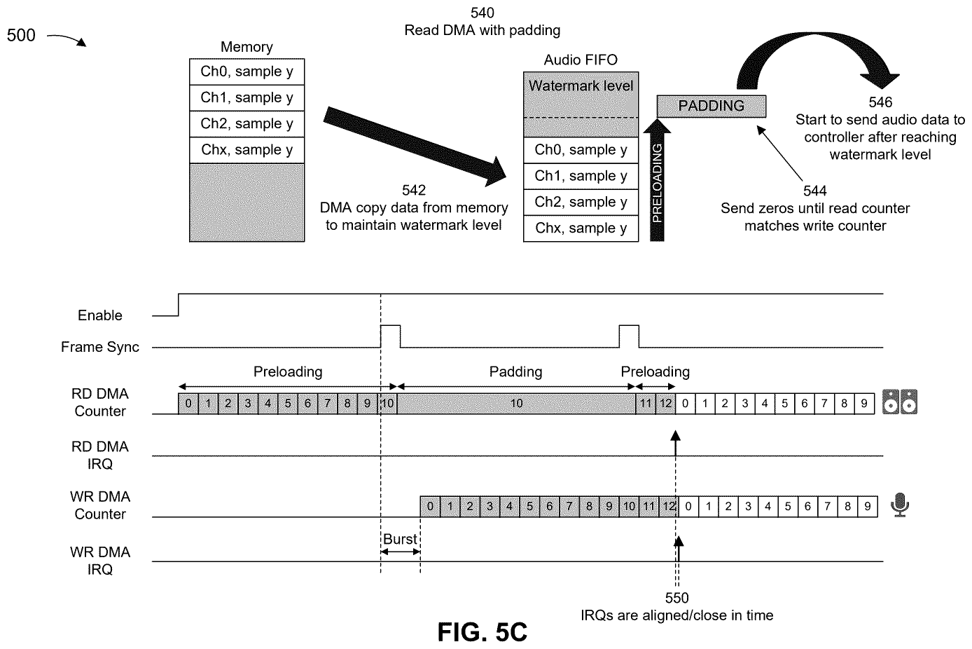

FIGS. 5A-5C are diagrams illustrating examples 500 associated with synchronous audio processing for reading and writing multiple audio streams, in accordance with the present disclosure. For example, although FIG. 4B provides techniques to ensure that DMA blocks associated with different audio interfaces start at the same time, read DMA blocks and write DMA blocks may be offset or misaligned in time due to a delta between read DMA period counters and write DMA period counters, where the DMA period counters are incremented to count a number of memory requests (e.g., a number of requests to read audio data from memory, or a number of requests to write audio data to memory). For example, referring to FIG. 5A, reference number 510 corresponds to example processing of a read DMA block. As shown by reference number 512, the read DMA block may prefetch audio data from memory and copy the audio data to an audio FIFO buffer (e.g., the ping or pong half of a circular buffer) until the audio data in the audio FIFO buffer reaches a threshold (or watermark) level to avoid buffer underrun. As shown by reference number 514, the read DMA block may then start to send the buffered audio data to a TDM audio interface sample-by-sample.

Alternatively, reference number 520 corresponds to example processing of a write DMA block. As shown by reference number 522, the write DMA block may copy audio data received from an audio interface sample-by-sample into an audio FIFO buffer (e.g., the ping or pong half of a circular buffer) until the audio data in the audio FIFO buffer reaches a threshold (or burst) level. As shown by reference number 524, after the threshold level of audio data has been buffered, the write DMA block may then start to write the buffered audio data to memory in a burst. As a result, because the read DMA block can prefetch audio data from memory while the write DMA block is waiting to access memory until the threshold level of audio data has been buffered, there may be an offset between the read and write DMA period counters, which may carry forward when later counter increments occur in periodic intervals. For example, FIG. 5B illustrates an example set of signals associated with a read DMA block and a write DMA block that have the same sampling rate. As shown in FIG. 5B, the read DMA period counter increments the read DMA period counter each time that memory is accessed to preload audio data into the audio FIFO buffer. As shown by reference number 530, the read DMA block and the write DMA block start to simultaneously send audio output data and capture audio input data after the write DMA block has collected the threshold amount of audio data associated with a burst. Accordingly, as shown by reference number 535, the read DMA period counter is incremented several times before the write DMA period counter begins to be incremented, resulting in a delta or offset between the read and write DMA period counters. The delta or offset may then lead to a delta or offset between the IRQs associated with the read and write DMA blocks (e.g., with the IRQs occurring when the period counters are reset to 0).

Accordingly, as shown in FIG. 5C, and by reference number 540, an audio controller may use a padding technique for one or more read DMA blocks to align the IRQs associated with read and write DMA blocks. For example, as shown by reference number 542, the read DMA block may prefetch audio data from memory and copy the audio data to an audio FIFO buffer (e.g., the ping or pong half of a circular buffer) until the audio data in the audio FIFO buffer reaches a threshold (or watermark) level to avoid buffer underrun, in a similar manner as described above. However, when a write DMA block has collected a threshold amount of data associated with an audio input burst, a signal may be sent to the read DMA block to stop the read DMA period counter from incrementing until the write DMA period counter equals the read DMA period counter. For example, as shown by reference number 544, the read DMA block may send zero data to the audio interface for a padding duration, where the padding duration may be calculated based on the approximate amount of time until the write DMA period counter will equal the read DMA period counter. For example, in some aspects, the padding duration may include a number of frames, which may be defined as the number of memory requests made by the read DMA block at the time of the signal indicating that the burst associated with the write DMA block has started, plus the number of transmit lanes, plus the number of frames in the audio burst. As shown by reference number 546, the read DMA block may then start to send the buffered audio data to a TDM audio interface sample-by-sample after the number of padding frames have elapsed. In this way, as shown by reference number 550, the padding duration may shift the read DMA period IRQ later in time, to compensate for the preloading period shifting the read DMA period IRQ earlier in time relative to the write DMA period IRQ.

As indicated above, FIGS. 5A-5C are provided as examples. Other examples may differ from what is described in connection with FIGS. 5A-5C.

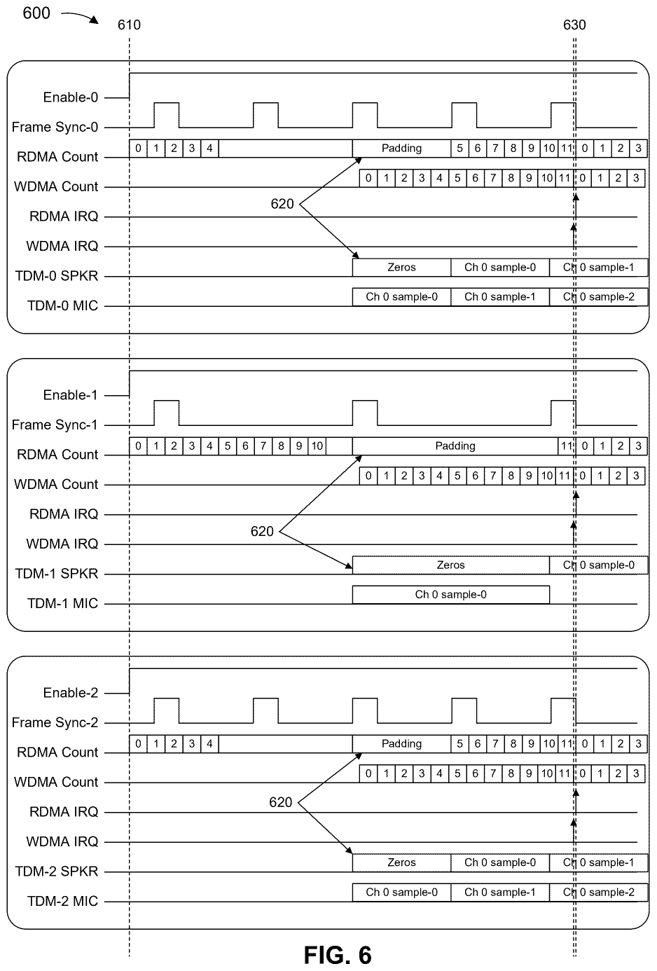

FIG. 6 is a diagram illustrating an example 600 associated with synchronous audio processing for multiple audio streams, in accordance with the present disclosure. More particularly, FIG. 6 illustrates example signals associated with different audio interfaces, which may be aligned or close in time using the techniques described above with respect to FIGS. 4A-4B and FIGS. 5A-5C. For example, as shown by reference number 610, an enable signal is sent to each audio interface at the same time to eliminate an offset associated with different enable controls for different audio interfaces. Furthermore, as shown by reference number 620, a read DMA block may send zero data to an audio interface, thereby stopping the read DMA period counter, for a number of padding frames that is calculated based on the number of memory requests performed to reach the watermark level or the number of preloading memory requests, the number of transmit lanes, and the burst length. Accordingly, the read DMA period counter may be stopped until the write DMA period counter equals the read DMA period counter, and the read DMA period counter may then be released. In this way, as shown by reference number 630, the period IRQs for the read DMA block and the write DMA block may be aligned or close in time. In addition, as described herein, each audio interface may start to process audio data at a common synchronous point when frame synchronization signals associated with the audio interfaces are all aligned.

As indicated above, FIG. 6 is provided as an example. Other examples may differ from what is described in connection with FIG. 6.

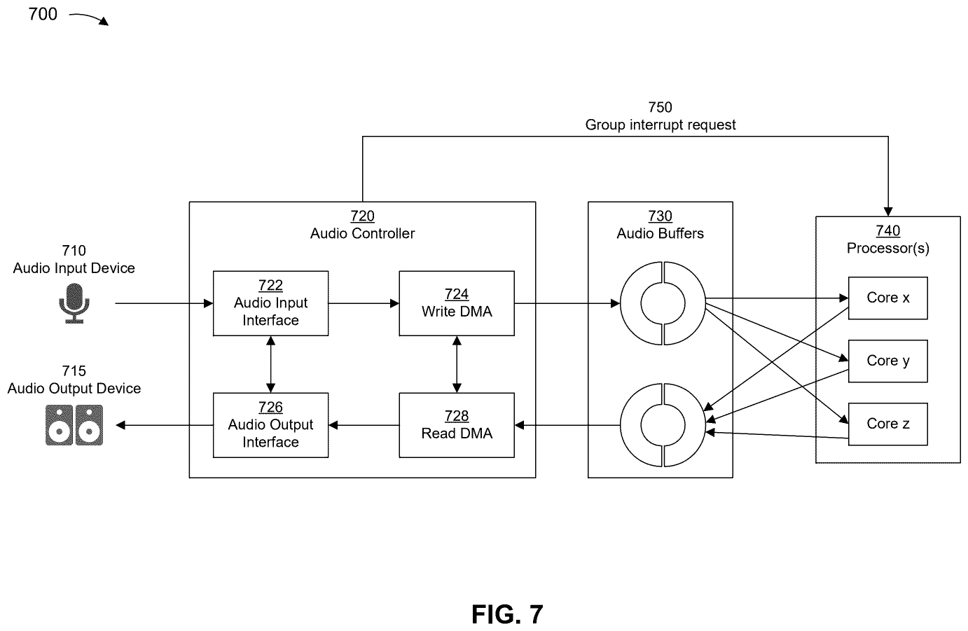

FIG. 7 is a diagram illustrating an example 700 associated with synchronous audio processing for multiple audio streams, in accordance with the present disclosure. As shown in FIG. 7, example 700 depicts an architecture for synchronous audio processing for multiple audio streams, where the architecture includes one or more audio input devices 710 and one or more audio output devices 715. The one or more audio input devices 710 and the one or more audio output devices 715 may be coupled to an audio controller 720 that includes an audio input interface 722 associated with a write DMA block 724 and an audio output interface 726 associated with a read DMA block 728. In addition, as shown, the architecture includes multiple audio buffers 730, which may be configured as circular buffers that have a ping half and a pong half, although other suitable buffering techniques may be used, and one or more processors 740, which may include processing units such as one or more processing cores.

As shown in FIG. 7, and by reference number 750, the architecture may support a group IRQ request to the one or more processors 740, and all processing units or cores may then access memory to support broadcasting audio output and input buffer writes across different processing units or cores. For example, the audio input interface 722 and write DMA block 724 may process audio input data from the audio input device 710 at the same time as the audio output interface 726 and read DMA block 728 processing audio output data to be provided to the audio output device 715 using the techniques described in more detail elsewhere herein. The audio controller 720 may receive, from the audio input interface 722, the audio output interface 726, and/or any other audio interfaces, multiple interrupt requests to trigger processing audio data associated with the multiple audio streams, where the multiple interrupts are synchronous or aligned in time. The audio controller 720 may then convert the multiple interrupt requests into the group interrupt request 750, which may be sent to the processor(s) 740 to trigger processing the multiple audio streams by the one or more processing units or cores.

In this way, some aspects described herein may enable synchronous processing for multiple audio without using software threads to synchronize audio streams. In addition, some aspects described herein may enable low-latency use cases via hardware-based synchronization, such as echo cancellation, road noise cancellation, and/or synchronizing multiple amplifiers to tune an audio system. Furthermore, by generating a single group IRQ, some aspects described herein may enable the processor(s) 740 to maintain high performance and efficiency in computation tasks. For example, a single group IRQ may result in minimal preemption of processing by the processing units or cores (e.g., each processing unit or core may experience only one interruption, in contrast to multiple interruptions in the case of asynchronous audio processing). Furthermore, some aspects may enable multi-core processing by broadcasting the same IRQ to all the cores, thereby sharing a workload among multiple cores to improve performance. In addition, some aspects allow multiple audio interfaces to work together in a single audio system, which enables high-quality audio even when a large number of audio channels are used (e.g., to satisfy an audio use case associated with 16 channels, even if each audio interface supports a maximum of only 8 channels). In addition, all processing units or cores process audio data at same time, which makes every power on cycle more predictable, and supports any use case that needs a synchronized startup.

As indicated above, FIG. 7 is provided as an example. Other examples may differ from what is described in connection with FIG. 7.

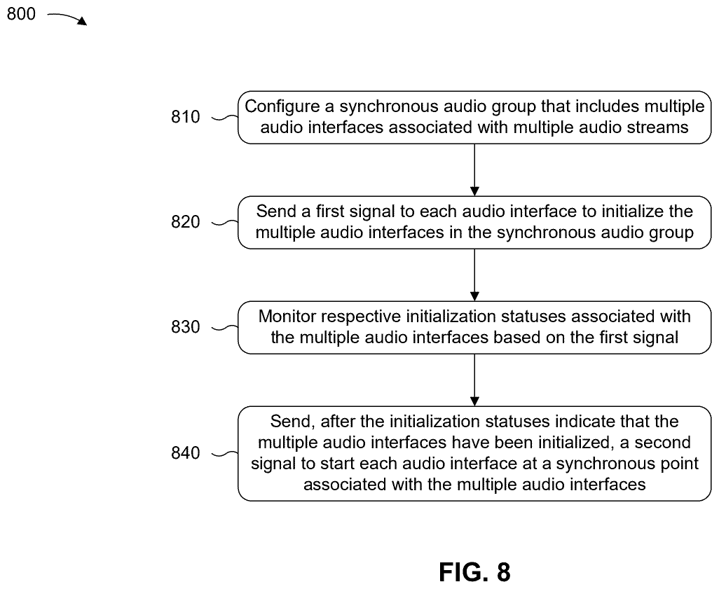

FIG. 8 is a flowchart of an example process 800 associated with synchronous audio processing for multiple audio streams. In some implementations, one or more process blocks of FIG. 8 are performed by an audio controller (e.g., audio controller 720). In some implementations, one or more process blocks of FIG. 8 are performed by another device or a group of devices separate from or including the audio controller, such as an electronic device (e.g., electronic device 110), an audio component (e.g., audio component 116), and/or one or more processors (e.g., processor(s) 740. Additionally, or alternatively, one or more process blocks of FIG. 8 may be performed by one or more components of device 200, such as processor 210, memory 215, input component 220, output component 225, communication component 230, and/or audio component 235.

As shown in FIG. 8, process 800 may include configuring a synchronous audio group that includes multiple audio interfaces associated with multiple audio streams (block 810). For example, the audio controller may configure a synchronous audio group that includes multiple audio interfaces associated with multiple audio streams, as described above.

As further shown in FIG. 8, process 800 may include sending a first signal to each audio interface to initialize the multiple audio interfaces in the synchronous audio group (block 820). For example, the audio controller may send a first signal to each audio interface to initialize the multiple audio interfaces in the synchronous audio group, as described above.

As further shown in FIG. 8, process 800 may include monitoring respective initialization statuses associated with the multiple audio interfaces based on the first signal (block 830). For example, the audio controller may monitor respective initialization statuses associated with the multiple audio interfaces based on the first signal, as described above.

As further shown in FIG. 8, process 800 may include sending, after the initialization statuses indicate that the multiple audio interfaces have been initialized, a second signal to start each audio interface at a synchronous point associated with the multiple audio interfaces (block 840). For example, the audio controller may send, after the initialization statuses indicate that the multiple audio interfaces have been initialized, a second signal to start each audio interface at a synchronous point associated with the multiple audio interfaces, as described above.

Process 800 may include additional implementations, such as any single implementation or any combination of implementations described below and/or in connection with one or more other processes described elsewhere herein.

In a first implementation, the multiple audio interfaces include a first audio interface associated with a first sampling rate and a second audio interface associated with a second sampling rate.

In a second implementation, alone or in combination with the first implementation, the synchronous point is a time when positive clock edges associated with the multiple audio interfaces all intersect.

In a third implementation, alone or in combination with one or more of the first and second implementations, process 800 includes receiving, from the multiple audio interfaces, multiple interrupt requests to trigger processing audio data associated with the multiple audio streams by the multiple audio interfaces, wherein the multiple interrupts are synchronous or aligned in time.

In a fourth implementation, alone or in combination with one or more of the first through third implementations, process 800 includes receiving, from the multiple audio interfaces, multiple interrupt requests to trigger processing audio data associated with the multiple audio streams by the multiple audio interfaces, wherein the multiple interrupts are synchronous or aligned in time, converting the multiple interrupt requests to a group interrupt request, and sending the group interrupt request to one or more cores to trigger processing the audio data associated with the multiple audio streams by the one or more cores.

In a fifth implementation, alone or in combination with one or more of the first through fourth implementations, the second signal causes each audio interface to use a read DMA block to read audio data from memory to a buffer or a write DMA block to write audio data from a buffer to memory.

In a sixth implementation, alone or in combination with one or more of the first through fifth implementations, process 800 includes copying, by a read DMA block, one or more audio samples from memory to a buffer, wherein a read DMA period counter is incremented each time that the read DMA block accesses the memory, stopping the read DMA period counter based on a write DMA block starting a write DMA period counter to write an audio burst to the memory, and releasing the read DMA period counter based on the write DMA period counter matching the read DMA period counter.

In a seventh implementation, alone or in combination with one or more of the first through sixth implementations, process 800 includes sending, by the read DMA block, zero data to a corresponding audio interface while the read DMA period counter is stopped.

In an eighth implementation, alone or in combination with one or more of the first through seventh implementations, the read DMA period counter is stopped for a number of frames that is based on one or more of a watermark level associated with the buffer, a number of transmission lanes, or a length of the audio burst.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The following provides an overview of some Aspects of the present disclosure:
Aspect 1: A method for synchronous audio processing, comprising: configuring, by an audio controller, a synchronous audio group that includes multiple audio interfaces associated with multiple audio streams; sending, by the audio controller, a first signal to each audio interface to initialize the multiple audio interfaces in the synchronous audio group; monitoring, by the audio controller, respective initialization statuses associated with the multiple audio interfaces based on the first signal; and sending, by the audio controller after the initialization statuses indicate that the multiple audio interfaces have been initialized, a second signal to start each audio interface at a synchronous point associated with the multiple audio interfaces.
Aspect 2: The method of Aspect 1, wherein the multiple audio interfaces include a first audio interface associated with a first sampling rate and a second audio interface associated with a second sampling rate.
Aspect 3: The method of any of Aspects 1-2, wherein the synchronous point is a time when positive clock edges associated with the multiple audio interfaces all intersect.
Aspect 4: The method of any of Aspects 1-3, further comprising: receiving, from the multiple audio interfaces, multiple interrupt requests to trigger processing audio data associated with the multiple audio streams by the multiple audio interfaces, wherein the multiple interrupts are synchronous or aligned in time.
Aspect 5: The method of any of Aspects 1-4, further comprising: receiving, from the multiple audio interfaces, multiple interrupt requests to trigger processing audio data associated with the multiple audio streams by the multiple audio interfaces, wherein the multiple interrupts are synchronous or aligned in time; converting the multiple interrupt requests to a group interrupt request; and sending the group interrupt request to one or more cores to trigger processing the audio data associated with the multiple audio streams by the one or more cores.
Aspect 6: The method of any of Aspects 1-5, wherein the second signal causes each audio interface to use a read DMA block to read audio data from memory to a buffer or a write DMA block to write audio data from a buffer to memory.
Aspect 7: The method of any of Aspects 1-6, further comprising: copying, by a read DMA block, one or more audio samples from memory to a buffer, wherein a read DMA period counter is incremented each time that the read DMA block accesses the memory; stopping the read DMA period counter based on a write DMA block starting a write DMA period counter to write an audio burst to the memory; and releasing the read DMA period counter based on the write DMA period counter matching the read DMA period counter.
Aspect 8: The method of Aspect 7, further comprising: sending, by the read DMA block, zero data to a corresponding audio interface while the read DMA period counter is stopped.
Aspect 9: The method of Aspect 7, wherein the read DMA period counter is stopped for a number of frames that is based on one or more of a watermark level associated with the buffer, a number of transmission lanes, or a length of the audio burst.
Aspect 10: A audio controller for wireless communication, comprising: one or more memories; and one or more processors, coupled to the one or more memories, configured to cause the audio controller to: configure a synchronous audio group that includes multiple audio interfaces associated with multiple audio streams; send a first signal to each audio interface to initialize the multiple audio interfaces in the synchronous audio group; monitor respective initialization statuses associated with the multiple audio interfaces based on the first signal; and send, after the initialization statuses indicate that the multiple audio interfaces have been initialized, a second signal to start each audio interface at a synchronous point associated with the multiple audio interfaces.
Aspect 11: The audio controller of Aspect 10, wherein the multiple audio interfaces include a first audio interface associated with a first sampling rate and a second audio interface associated with a second sampling rate.
Aspect 12: The audio controller of any of Aspects 10-11, wherein the synchronous point is a time when positive clock edges associated with the multiple audio interfaces all intersect.
Aspect 13: The audio controller of any of Aspects 10-12, wherein the one or more processors are further configured to cause the audio controller to: receive, from the multiple audio interfaces, multiple interrupt requests to trigger processing audio data sampled by the multiple audio interfaces.
Aspect 14: The audio controller of any of Aspects 10-13, wherein the one or more processors are further configured to cause the audio controller to: receive, from the multiple audio interfaces, a group interrupt request to trigger processing audio data sampled by the multiple audio interfaces; and send the group interrupt request to one or more cores to trigger processing the audio data sampled by the multiple audio interfaces by the one or more cores.
Aspect 15: The audio controller of any of Aspects 10-14, wherein the second signal causes each audio interface to use a read DMA block to read audio data from memory to a buffer or a write DMA block to write audio data from a buffer to memory.
Aspect 16: The read DMA block of any of Aspects 10-15, wherein the one or more processors are further configured to cause the audio controller to: copy one or more audio samples from memory to a buffer, wherein a read DMA period counter is incremented each time that the read DMA block accesses the memory; stop the read DMA period counter based on a write DMA block starting a write DMA period counter to write an audio burst to the memory; and release the read DMA period counter based on the write DMA period counter matching the read DMA period counter.
Aspect 17: The read DMA block of Aspect 16, wherein the one or more processors are further configured to cause the audio controller to: send zero data to a corresponding audio interface while the read DMA period counter is stopped.
Aspect 18: The DMA of Aspect 16, wherein the read DMA period counter is stopped for a number of frames that is based on one or more of a watermark level associated with the buffer, a number of transmission lanes, or a length of the audio burst.
Aspect 19: A non-transitory computer-readable medium storing a set of instructions for wireless communication, the set of instructions comprising: one or more instructions that, when executed by one or more processors of an audio controller, cause the audio controller to: configure a synchronous audio group that includes multiple audio interfaces associated with multiple audio streams; send a first signal to each audio interface to initialize the multiple audio interfaces in the synchronous audio group; monitor respective initialization statuses associated with the multiple audio interfaces based on the first signal; and send, after the initialization statuses indicate that the multiple audio interfaces have been initialized, a second signal to start each audio interface at a synchronous point associated with the multiple audio interfaces.
Aspect 20: The non-transitory computer-readable medium of Aspect 19, wherein the one or more instructions further cause the audio controller to: receive, from the multiple audio interfaces, a group interrupt request to trigger processing audio data sampled by the multiple audio interfaces; and send the group interrupt request to one or more cores to trigger processing the audio data sampled by the multiple audio interfaces by the one or more cores.
Aspect 21: A system configured to perform one or more operations recited in one or more of Aspects 1-20.
Aspect 22: An apparatus comprising means for performing one or more operations recited in one or more of Aspects 1-20.
Aspect 23: A non-transitory computer-readable medium storing a set of instructions, the set of instructions comprising one or more instructions that, when executed by a device, cause the device to perform one or more operations recited in one or more of Aspects 1-20.
Aspect 24: A computer program product comprising instructions or code for executing one or more operations recited in one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method for synchronous audio processing, comprising:
configuring, by an audio controller, a synchronous audio group that includes multiple audio interfaces associated with multiple audio streams;
sending, by the audio controller, a first signal to each audio interface to initialize the multiple audio interfaces in the synchronous audio group;
monitoring, by the audio controller, respective initialization statuses associated with the multiple audio interfaces based on the first signal; and
sending, by the audio controller after the initialization statuses indicate that the multiple audio interfaces have been initialized, a second signal to start each audio interface at a synchronous point associated with the multiple audio interfaces.

2. The method of claim 1, wherein the multiple audio interfaces include a first audio interface associated with a first sampling rate and a second audio interface associated with a second sampling rate.

3. The method of claim 1, wherein the synchronous point is a time when positive clock edges associated with the multiple audio interfaces all intersect.

4. The method of claim 1, further comprising:
receiving, from the multiple audio interfaces, multiple interrupt requests to trigger processing audio data associated with the multiple audio streams by the multiple audio interfaces, wherein the multiple interrupts are synchronous or aligned in time.

5. The method of claim 1, further comprising:
receiving, from the multiple audio interfaces, multiple interrupt requests to trigger processing audio data associated with the multiple audio streams by the multiple audio interfaces, wherein the multiple interrupts are synchronous or aligned in time;
converting the multiple interrupt requests to a group interrupt request; and
sending the group interrupt request to one or more cores to trigger processing the audio data associated with the multiple audio streams by the one or more cores.

6. The method of claim 1, wherein the second signal causes each audio interface to use a read direct memory access (DMA) block to read audio data from memory to a buffer or a write DMA block to write audio data from a buffer to memory.

7. The method of claim 1, further comprising:
copying, by a read direct memory access (DMA) block, one or more audio samples from memory to a buffer, wherein a read DMA period counter is incremented each time that the read DMA block accesses the memory;
stopping the read DMA period counter based on a write DMA block starting a write DMA period counter to write an audio burst to the memory; and
releasing the read DMA period counter based on the write DMA period counter matching the read DMA period counter.

8. The method of claim 7, further comprising:
sending, by the read DMA block, zero data to a corresponding audio interface while the read DMA period counter is stopped.

9. The method of claim 7, wherein the read DMA period counter is stopped for a number of frames that is based on one or more of a watermark level associated with the buffer, a number of transmission lanes, or a length of the audio burst.

10. A audio controller for wireless communication, comprising:
one or more memories; and
one or more processors, coupled to the one or more memories, configured to cause the audio controller to:
configure a synchronous audio group that includes multiple audio interfaces associated with multiple audio streams;
send a first signal to each audio interface to initialize the multiple audio interfaces in the synchronous audio group;
monitor respective initialization statuses associated with the multiple audio interfaces based on the first signal; and
send, after the initialization statuses indicate that the multiple audio interfaces have been initialized, a second signal to start each audio interface at a synchronous point associated with the multiple audio interfaces.

11. The audio controller of claim 10, wherein the multiple audio interfaces include a first audio interface associated with a first sampling rate and a second audio interface associated with a second sampling rate.

12. The audio controller of claim 10, wherein the synchronous point is a time when positive clock edges associated with the multiple audio interfaces all intersect.

13. The audio controller of claim 10, wherein the one or more processors are further configured to cause the audio controller to:
receive, from the multiple audio interfaces, multiple interrupt requests to trigger processing audio data associated with the multiple audio streams by the multiple audio interfaces, wherein the multiple interrupts are synchronous or aligned in time.

14. The audio controller of claim 10, wherein the one or more processors are further configured to cause the audio controller to:
receive, from the multiple audio interfaces, multiple interrupt requests to trigger processing audio data associated with the multiple audio streams by the multiple audio interfaces, wherein the multiple interrupts are synchronous or aligned in time;
convert the multiple interrupt requests to a group interrupt request; and
send the group interrupt request to one or more cores to trigger processing the audio data associated with the multiple audio streams by the one or more cores.

15. The audio controller of claim 10, wherein the second signal causes each audio interface to use a read direct memory access (DMA) block to read audio data from memory to a buffer or a write DMA block to write audio data from a buffer to memory.

16. The audio controller of claim 10, wherein the one or more processors are further configured to cause the audio controller to:
copy one or more audio samples from memory to a buffer, wherein a read DMA period counter is incremented each time that the read DMA block accesses the memory;
stop the read DMA period counter based on a write DMA block starting a write DMA period counter to write an audio burst to the memory; and
release the read DMA period counter based on the write DMA period counter matching the read DMA period counter.

17. The audio controller of claim 16, wherein the one or more processors are further configured to cause the audio controller to:
send zero data to a corresponding audio interface while the read DMA period counter is stopped.

18. The audio controller of claim 16, wherein the read DMA period counter is stopped for a number of frames that is based on one or more of a watermark level associated with the buffer, a number of transmission lanes, or a length of the audio burst.

19. A non-transitory computer-readable medium storing a set of instructions for wireless communication, the set of instructions comprising:
one or more instructions that, when executed by one or more processors of an audio controller, cause the audio controller to:
configure a synchronous audio group that includes multiple audio interfaces associated with multiple audio streams;
send a first signal to each audio interface to initialize the multiple audio interfaces in the synchronous audio group;
monitor respective initialization statuses associated with the multiple audio interfaces based on the first signal; and
send, after the initialization statuses indicate that the multiple audio interfaces have been initialized, a second signal to start each audio interface at a synchronous point associated with the multiple audio interfaces.

20. The non-transitory computer-readable medium of claim 19, wherein the one or more instructions further cause the audio controller to:
receive, from the multiple audio interfaces, multiple interrupt requests to trigger processing audio data associated with the multiple audio streams by the multiple audio interfaces, wherein the multiple interrupts are synchronous or aligned in time;
convert the multiple interrupt requests to a group interrupt request; and
send the group interrupt request to one or more cores to trigger processing the audio data associated with the multiple audio streams by the one or more cores.
